(19) United States
(12) Patent Application Publication
(10) Pub. No.: US 2005/0053245 A1
(43) Pub. Date: Mar. 10, 2005

(54) 5.1 Channel signal output mixer circuit for earphone

(76) Inventors: Chen-Hua Hsu, Taoyuan (TW); Hsuan-Wei Huang, Keelung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/691,495

(22) Filed: Oct. 24, 2003

(30) Foreign Application Priority Data
Sep. 9, 2003 (TW) 092124806

(51) Int. Cl. H04R 1/10; H04R 5/02

(52) U.S. Cl. 381/74; 381/309; 381/119

(57) ABSTRACT

A 5.1 channel signal output mixer circuit for earphone using step gain amplification unit comprising a filtering gain unit, a mixing gain unit and a noise reduction gain unit, wherein said filtering gain unit obtaining a bandwidth-adjusted subwoofer signal from two waveform shaping circuits, said mixing gain mixing said subwoofer signal with an output signal of a front channel to form a first signal, said noise reduction gain receiving said first signal for noise removal to form a signal and outputting said signal to a speaker.

### BACKGROUND OF THE INVENTION

1. Field of the Invention

The present invention discloses a signal adjustment and control method using waveform shaping and mixing techniques for 5.1 channel audio earphone, thus allowing for excellent output quality of mixed signal while keeping the cost down.

2. Description of the Prior Art

FIG. 1 shows a prior art stereo system, wherein the home stereo equipment 1007 is surrounded by audio devices to provide better sound effects to people 1008. The audio devices usually comprises a front left (FL) speaker 1001, a front right (FR) speaker 1002, a rear left (RL) speaker 1003 and a rear right (RR) speaker 1004, along with a central speaker (C) 1005 and a subwoofer speaker (SW) 1006, to produce the so-called 5.1 channel sound, wherein the SW 1006 can be placed anywhere due to its omnidirectional broadcasting capability.

In prior art stereo systems, different combinations of amplifiers, mixers, equalizers, speakers and so on can produce or complement the Dolby sound signal. But with the widespread low-price game consoles (such as PS2, XBox), MP3 players and DVD players emerging, the high price tag and space-consuming problems of stereo systems are not suitable for most people's need. Besides, limited living space does not allow for high-volume playback of stereo systems. In order to satisfy personal entertainment needs and for people to enjoy Dolby sound effects, earphone emerges as an alternative solution to experience Dolby sound.

Subwoofer waveform adjustment devices, such as LM538 chip from National Semiconductor, are already presented in prior art home stereo systems to provide waveform adjustment of subwoofer signals. However, home stereo systems comprise various “high power” audio playback devices, which can damage the “low power” earphone when coupling to it. Besides, since the frequency response of earphone does not conform to that of home stereo systems, signal distortion may occur. Furthermore, powerful signal output may harm one's ears. Therefore, it is not recommended to apply the signal adjustment devices of home stereo systems directly to earphones.

For the earphones currently in the market to produce Dolby sound effects, an earphone is implemented with several speakers within. Shown in FIG. 2 and FIG. 3, the earphone mimics the configuration of left speakers. In FIG. 2, every earphone 2000 is implemented with 4 speakers, namely the front left speaker 1001, rear left speaker 1003, central speaker 1005 and subwoofer speaker 1006. Though this kind of earphones can directly output the Dolby sound, however, the different characteristics of speakers used in earphone compared to that of speakers used in home stereo systems could lead to degraded output sound and far-less subwoofer effects than expected. Meanwhile, since we need greater output to drive the subwoofer unit, while output gain can be attained by using the circuit depicted in FIG. 4, it is very likely that problems of signal distortion and excessive filtering may degrade the signal. Again, this configuration is likely to face the challenges such as higher speaker cost and increased weight, which are not good to the price and usability of the earphone.

The earphone 3000 in FIG. 3 gets rid of subwoofer speaker 1006, for only 3 speakers being installed. This earphone provides low cost solution and sufficient space to implement tube for echo effects to generate better ambient feel. Since the earphone weighs less, it can reduce the burden of the user. Nevertheless, the earphone is unable to provide complete Dolby sound effects due to lack of subwoofer signal. Therefore, how to choose between cost and sound quality has become a critical issue.

### SUMMARY OF THE INVENTION

The mixer device disclosed in the present invention can trim the signal waveform of the subwoofer 1006 and mix it with the signal coming from front speakers 1001, 1002 and provide output to the earphone. The mixer circuit enables the 3-speaker earphone 3000 to not only produce subwoofer effects but also remove the noise and signal distortion problem resulted from signal amplification to reproduce excellent sound quality.

The objective of the present invention is to provide a mixer circuit using step gain amplification unit comprising filtering gain/mixing gain/noise reduction gain for earphone, thus allowing for excellent output quality of mixed signal while keeping the cost down.

### BRIEF DESCRIPTION OF THE DRAWINGS

FIG. 1: prior art 5.1 channel audio output configuration;

FIG. 2: prior art Dolby sound earphone one (left ear);

FIG. 3: prior art Dolby sound earphone two (right ear)

FIG. 4: prior art subwoofer gain amplifier circuit;

FIG. 5: mixing procedures of the invention;

FIG. 6: mixer circuit;

FIG. 7: the result with/without filtering gain;

FIG. 8: the result with/without mixing gain; and

FIG. 9: the result with/without noise reduction gain.

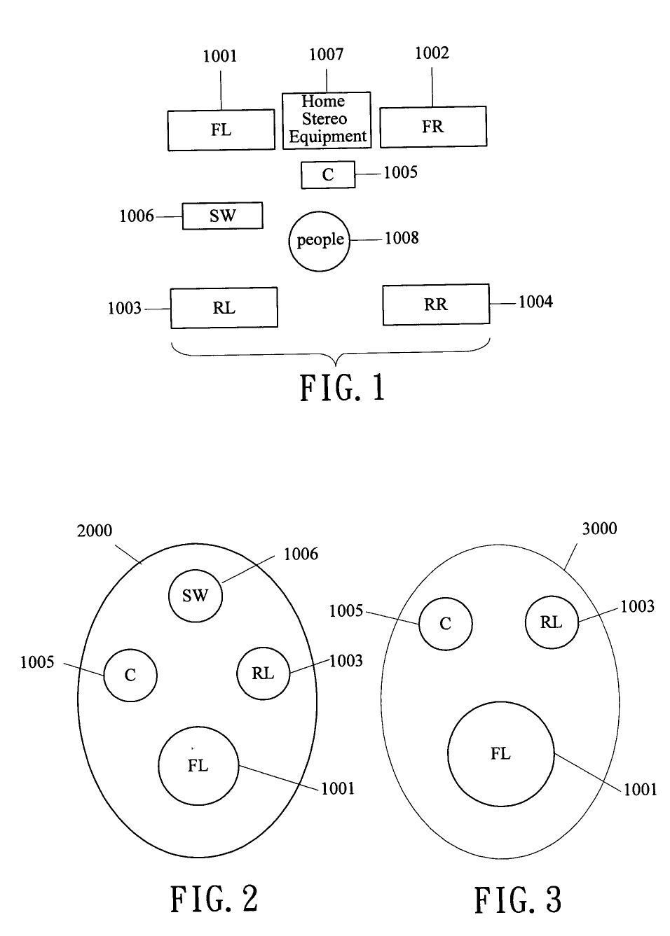

### DETAILED DESCRIPTION OF THE PREFERRED EMBODIMENT

The mixer device disclosed in the present invention can trim the signal waveform of the subwoofer 1006 and mix it with the signal coming from front speakers 1001, 1002 and provide output to the earphone. The mixer circuit enables the 3-speaker earphone 3000 to not only produce subwoofer effects but also remove the noise and signal distortion problem resulted from signal amplification to reproduce excellent sound quality.

Please refer to FIG. 5, which shows a preferred embodiment of the present invention. In the following paragraph, we shall use the earphone in FIG. 3 as an example to illustrate the signal processing of the earphone. The mixer circuit 100 comprises 3 amplifier circuits, namely filtering gain 200, mixing gain 300 and noise reduction gain 400 to provide graded step gain effects.

Among the amplifier circuits, the filtering gain 200 receives the subwoofer signal (SWS) 101 to produce a bandwidth-adjusted signal, along with the front left signal (FLS) 102, acting as the input signals of the mixing gain 300.

The mixing gain 300 mixes the two signals described above, amplifies the combined signal, which serves as the input signal of noise reduction gain 400.

The noise reduction gain 400 can be treated as a power amplifier. It can provide signal gain and noise removal capability in accordance with the characteristics of the speakers implemented in the earphone.

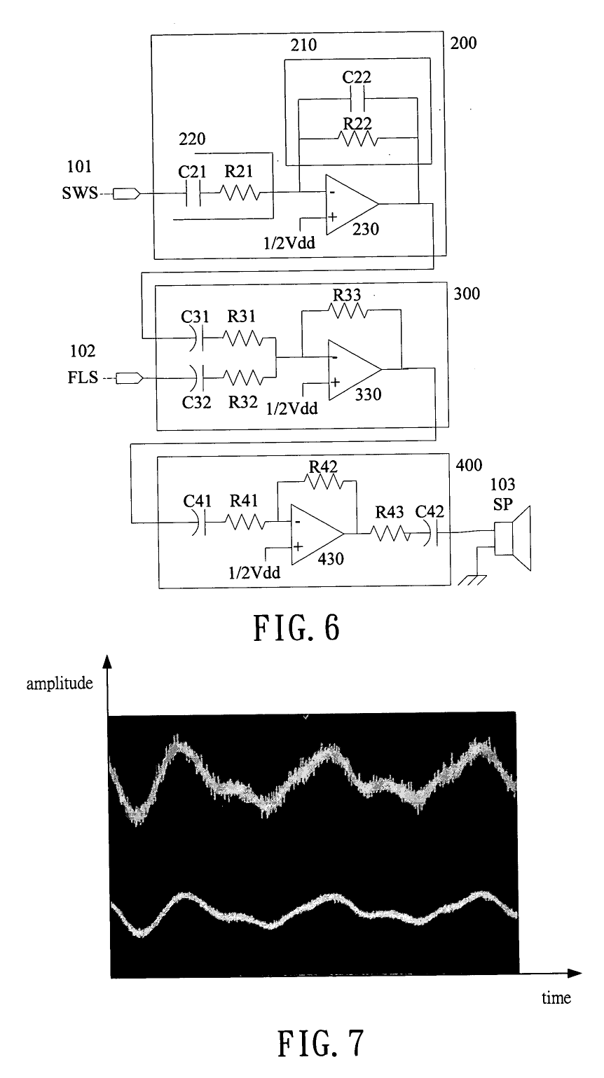

Please refer to the filtering gain 200 shown in FIG. 6, wherein the filtering gain comprises a front-end filtering circuit 210 for subwoofer signal, a rear-end filtering circuit 220 for subwoofer signal and a subwoofer gain amplifier 230. The front-end filtering circuit 210 and rear-end filtering circuit 220 respectively comprise nonpolarity capacitors C21, C22 and resistors R21, R22. The nonpolarity capacitor C21 determines the extent of adjustment for the front-end waveform of bandwidth of subwoofer signal. When the value of nonpolarity capacity becomes smaller, the bandwidth will become narrower, and the harsher the sound will be. On the contrary, if the value of nonpolarity capacity becomes bigger, the wider the bandwidth will become wider, and the smoother the adjusted subwoofer signal will be. The nonpolarity capacitor C22 determines the extent of adjustment for the rear-end waveform of bandwidth of subwoofer signal. A smaller value for the capacitor can filter out higher frequency signal and noises to provide cleaner subwoofer signal. In order to provide effective and smooth output of subwoofer signal, the present invention preferably adopts nonpolarity capacitor C21 having high capacitance and nonpolarity capacitor C22 having low capacitance, with the input 101 and output 104 signal waveforms shown in FIG. 7.

The resistors R21 and R22 provide the gain ratio for subwoofer amplifier. In a preferred embodiment of present invention, the optimal value is 3. Nevertheless, the resistor ratio is subjected to change based on the input signal and the characteristics of the speaker being applied. The objective of waveform shaping is intended to match the sound reproduction capability of the speaker of earphone, and to adjust the period and the emerging time of a subwoofer signal to provide comfortable listening experience when the subwoofer speaker is near the listener.

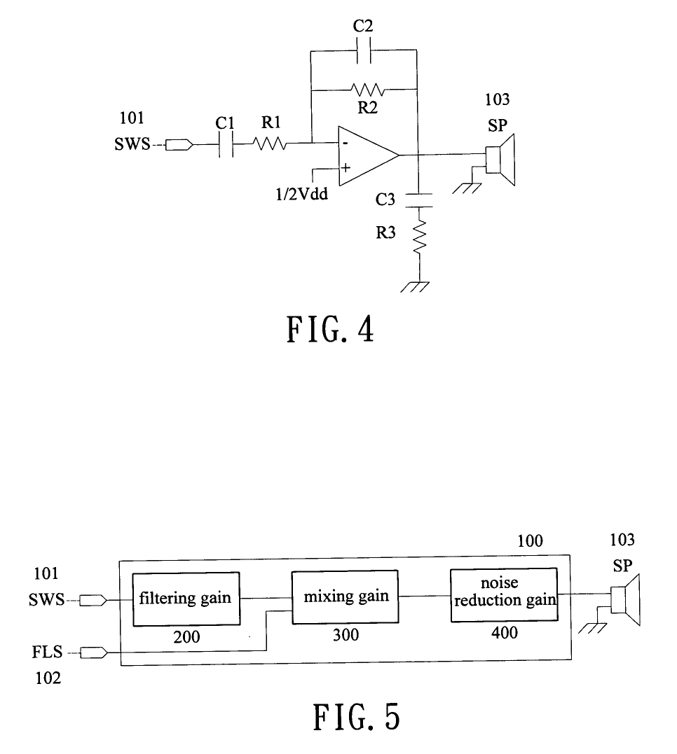

Compared to prior art shown in FIG. 4, the subwoofer signal provides more suitable bandwidth adjustment based on the characteristics of the earphone's speaker. Furthermore, bypassing capacitor C3 achieves better integrity of the subwoofer signal, while the mixing gain 300 provides wider, purer and smoother subwoofer signal.

The mixing gain 300 receives an output from the filtering gain 200 and a signal from the front left speaker 102. Capacitors C31 and C32 are big enough to allow wider-bandwidth front left signal to pass. When the wide-bandwidth front left signal mixes with the adjusted subwoofer signal, the subwoofer signal becomes smoother and provides deeper sound. This is why the subwoofer sound effects in the present invention are far better than those of the prior art circuit. Resistors R31 and R32 provide various mixing ratios and clarify the mixing signal. Based on different ratios of R31 and R32, we can have different mixing effects for DVD analog output, Dolby digital and DTS output. In a preferred embodiment of the present invention, in order to achieve optimized sound effects, the ratio for mixing the front left signal and the adjusted subwoofer signal is 1:1. Naturally, the ratio used herein is not limited to certain embodiments, and different ratios are applicable in different implementations or different mixing types. The resistors R33, R31 and R32 provide the gain ratio for mixing gain amplifier 330. The noise reduction gain 400 receives an output from the mixing gain 300, wherein capacitor C41 and resistors R41, R42 act like capacitor C31 and resistors R31, R32 in the mixing gain 300, and the noise reduction gain 400 comprises resistor R43 and capacitor C42 as well. The function of resistor R43 is to remove white noise. White noise is the noise generated by the amplifier circuit itself, white noise increases when the gain becomes larger. There are various ways to remove the white noise, RC filtering circuits are commonly seen in different applications. The problem with RC filtering circuit is that it also filters out other signals and results in serious signal distortion or lost signal. In the present invention, the single-cascaded resistor R43 can filter out white noise and in the meantime, preserves the desired signal. Capacitor C42 acts like an energy bank to output signal to the earphone's speaker 103.

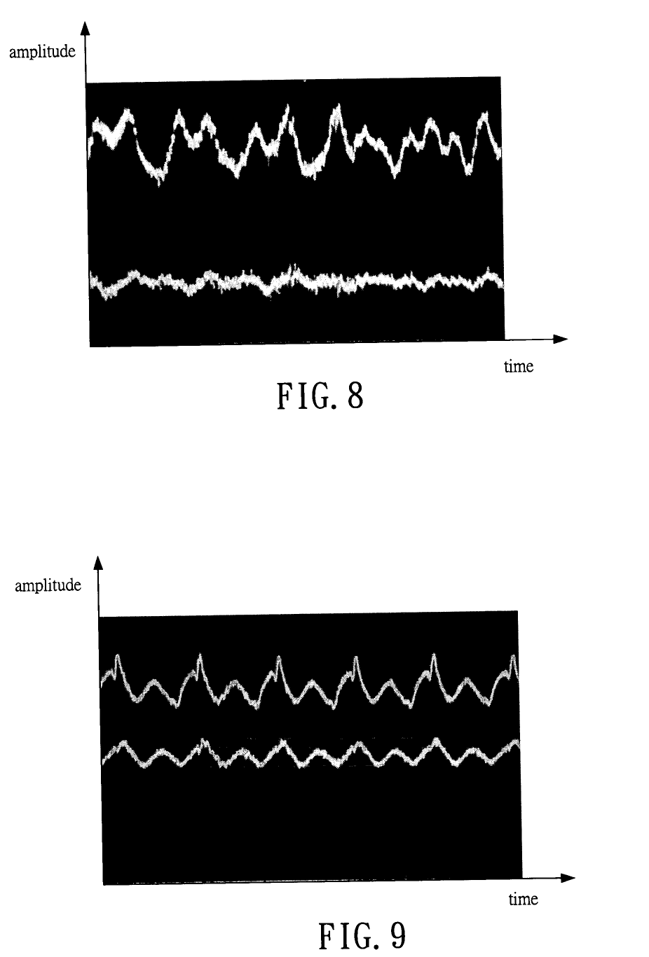

The circuit disclosed herein attains excellent balance of cost and sound quality, that is, the cost decreases while the sound quality improves. FIG. 7, 8 and 9 show the different outcomes in various stages, wherein the horizontal axle represents passing time and the vertical axle is amplitude. In FIG. 7, the upper waveform is the waveform before passing through the filtering gain, and the lower waveform is the one after passing through the filtering gain, wherein the noise residing in the subwoofer signal has been clearly removed, and the bandwidth has been adjusted to show a smoother waveform. In FIG. 8, the lower waveform is the output signal of traditional circuit. Through the application of the mixer circuit of the present invention, we obtain the upper waveform. It is noted that the signal mixes with the subwoofer signal and then outputs a vibrant waveform. FIG. 9 shows the effect of the noise reduction gain, where the upper waveform is the waveform before passing through the noise reduction gain, and the lower waveform is the one after passing through the noise reduction gain. It is easy to see that the noise residing in the original signal has been clearly removed.

The mixer circuit disclosed herein can keep THD (Total Harmonic Distortion) value consistent between 20 Hz to 100 KHz without being affected by high frequency noises, thus improving the clarity and stability of audio signal. Table 1 shows different outcomes of the mixer circuit of the present invention and traditional circuit.

TABLE 1

| | | S/N (dB) | | | |
|---|---|---|---|---|---|
| | | | The mixer | | |
| Sinusoidal | | | circuit | THD (%) | |
| wave input | | Traditional | disclosed | Traditional | The mixer circuit |
| 100 mV | | circuit | herein | circuit | disclosed herein |
| 20 | Hz | 50 | 53 | 4.2 | 2.3 |
| 200 | Hz | 53 | 55 | 2.33 | 0.55 |
| 1 | K Hz | 53.5 | 54 | 3.78 | 0.53 |
| 5 | K Hz | 53.4 | 54 | 3.52 | 0.55 |
| 10 | K Hz | 53 | 54 | 2.73 | 0.54 |
| 15 | K Hz | 53 | 52 | 2.43 | 0.5 |
| 20 | K Hz | 53 | 59 | 2.26 | 0.52 |

Although the present invention has been described with the illustration of earphone configuration in FIG. 3. Those who skilled in the art should know that the present invention is not limited to the use of earphone, and the signal mixing technique is not limited to the signal mixing of subwoofer signal and other signals. Many changes and modifications of the earphone configuration and the signal mixing technique in the above described embodiment of the invention can, of course, be carried out without departing from the scope thereof.

1. A 5.1 channel signal output mixer circuit for earphone, comprising:
a filtering gain unit;
a mixing gain unit;
a noise reduction gain unit;
wherein said filtering gain unit adjusting a period and an emerging time of a subwoofer signal and magnifying said subwoofer signal; said mixing gain unit mixing said adjusted subwoofer signal with an output signal of a front channel proportionally to form a first signal and magnifying thereof; said noise reduction gain unit removing a high frequency noise from said magnified first signal and magnifying thereof to provide a signal; wherein signal processing through stages comprising said filtering gain unit, said mixing gain unit and said noise reduction gain unit providing consistent signal distortion and achieving optimized clarity and stability of said signal

2. The circuit of claim 1, wherein said filtering gain unit comprises two RC filtering circuits for adjusting a front-end waveform and a rear-end waveform of a bandwidth of said subwoofer signal respectively.

3. The circuit of claim 1, wherein said mixing gain unit comprises a resistor pair having variable resistance ratio to generate different mixing ratios.

4. The circuit of claim 1, wherein an amplifier output of said noise reduction gain unit couples a resistor to remove a high frequency noise resulted from magnifying effect of said mixer circuit.

5. The circuit of claim 1, wherein said mixer circuit is implemented in a external case coupling to earphone and a 5.1 channel audio source respectively.

6. The circuit of claim 1, wherein said mixer circuit is implemented in a DVD device having a 5.1 channel output jack for earphone.

7. The circuit of claim 1, wherein said mixer circuit is implemented in a TV equipped with a DVD device, said TV comprising a 5.1 channel output jack for earphone.
